(19) United States
(12) Patent Application Publication
(10) Pub. No.: US 2007/0118682 A1
(43) Pub. Date: May 24, 2007

(54) Method and apparatus for interfacing and managing NAND flash memory

(75) Inventors: Hao Zhang, Beijing (CN); DaBei Shi, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 11/421,070

(22) Filed: May 31, 2006

(30) Foreign Application Priority Data
Nov. 21, 2005 (CN) 200510123578.7

(51) Int. Cl. G06F 12/00

(52) U.S. Cl. 711/103

(57) ABSTRACT

Techniques for providing a NAND flash memory interface being compatible with various NAND flash memories and minimizing the impact on an embedded microprocessor at the same time are disclosed. According to one aspect of the techniques, a NAND flash memory interface is provided for coupling to various types of NAND flash memories. The NAND flash memory interface comprises a protocol selection unit and a waveform generation unit. The protocol selection unit is provided for selecting adequate interface protocols for a NAND flash memory coupled thereto according to type parameters of the coupled NAND flash memory. The waveform generation unit is provided for generating an interface time sequence for operating the coupled NAND flash memory according to the interface protocol selected by the protocol selection unit.

### BACKGROUND OF THE INVENTION

1. Field of the Invention

The present invention relates to an interface device, and especially to an interface device for a NAND flash memory, and method and apparatus for managing the NAND flash memory interface device.

2. Description of Related Art

A NAND flash memory includes a plurality of blocks, each of which has a predetermined size for preserving data information similar to a cluster of a hark disk. Read/write operation to the NAND flash memory is conducted with a block and a page as a processed unit. I/O ports with 8 bits, for instance, are used on the NAND flash memory. Its fundamental working principle is accessing data in sequence. Namely, only when the read/write operation for one block is accomplished, the read/write operation for next block begins. In another word, the access mode is in serial but not in parallel.

Generally, the NAND flash memory has no memory controller itself. Management of the NAND flash memory is done via an embedded microprocessor with the help of software. In addition to various strategic and tactic management, the embedded microprocessor is configured to be also responsible for specifically read/write operations. A simple physical interface made up of lathes is provided between the NAND flash memory and the embedded microprocessor. When the embedded microprocessor employs relatively high frequency to access the NAND flash memory via the simple physical interface, an interface time sequence for the NAND flash memory will be generated according to read/write functions in a firmware.

However, there are several disadvantages in the prior art physical interface. Partly, the whole interface time sequence is generated by the firmware functions, and the embedded microprocessor has to spend several clock circles in executing one assembler instruction, hence the embedded microprocessor must work at a high frequency which is several times higher than that of the simple physical interface. Thus, the embedded microprocessor with low working frequency is not adequate. At the same time, a lot of other resources of the embedded microprocessor are taking place to mange the NAND flash memory. Nevertheless, an embedded microprocessor operating at a higher frequency often leads to more power consumption.

Furthermore, different NAND flash memories may require different interface time sequences. Each interface time sequence includes two aspects, one is the interface time sequence speed, and the other is the interface time sequence structure, namely, the interface time sequence waveform. The interface time sequence speed is determined by a clock signal of the physical interface based on which the interface time sequence is generated. The interface time sequence structure is determined by read/write functions in the firmware. In order to be compatible with various NAND flash memories, various versions of firmware have to be employed, which is often difficult to implement. Additionally, different NAND flash memories may require different interface time sequence speeds, it is difficult for the conventional physical interface to optimize the speed of the NAND flash memory because the conventional interface time sequence is generated based on the same clock.

Thus there is a need for providing a NAND flash memory interface being compatible with various NAND flash memories and minimizing the impact on an embedded microprocessor at the same time.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention pertains to techniques for providing a NAND flash memory interface being compatible with various NAND flash memories and minimizing impact on an embedded microprocessor simultaneously are disclosed. According to one aspect of the techniques, a NAND flash memory interface is provided for coupling to various NAND flash memories. The NAND flash memory interface comprises a protocol selection unit and a waveform generation unit. The protocol selection unit is provided for selecting adequate interface protocols for a NAND flash memory coupled thereto according to type parameters of the coupled NAND flash memory. The waveform generation unit is provided for generating an interface time sequence for operating the coupled NAND flash memory according to the interface protocol selected by the protocol selection unit.

The present invention may be implemented as a device and a part of system. According to one embodiment, the present invention is an NAND flash memory interface capable of coupling to various types of NAND flash memories, NAND flash memory interface comprises a protocol selection unit provided for selecting adequate interface protocols for a NAND flash memory coupled thereto according to type parameters of the NAND flash memory; a waveform generation unit provided for generating an interface time sequence for operating the NAND flash memory according to the interface protocol selected by the protocol selection unit.

One of the features, benefits and advantages in the present invention is to provide a NAND flash memory interface being compatible with various types of NAND flash memories and minimizing the impact on an embedded microprocessor at the same time.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 is a block diagram schematically showing a management apparatus according to one embodiment of the present invention;

FIG. 2 is a block diagram schematically showing an waveform generation unit shown in FIG. 1; and

FIGS. 3(a)-(b) illustrates a timing sequence diagram showing an interface time sequence generated by a waveform generation unit shown in FIG. 1.

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

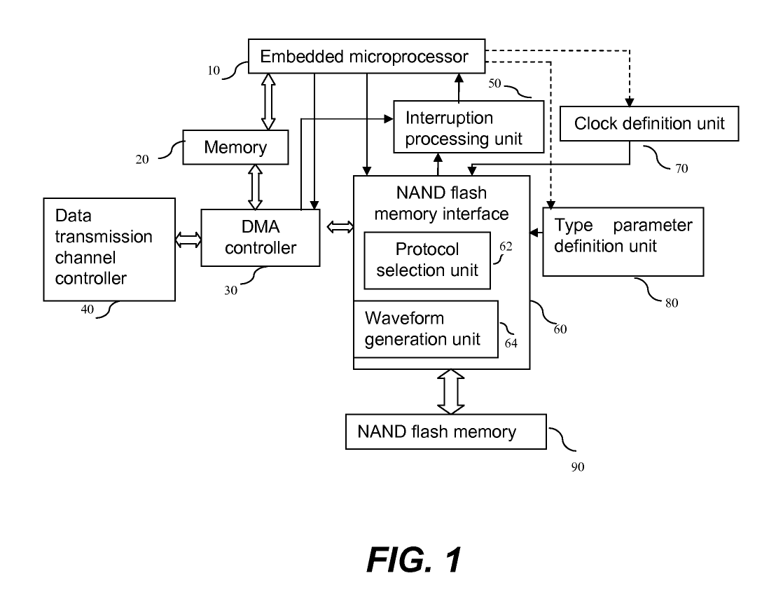

FIG. 1 is a block diagram of a management apparatus 200 according to one embodiment of the present invention. The management apparatus 200 comprises an embedded microprocessor 10, a memory 20 for the embedded microprocessor 10, a direct memory access (DMA) controller 30, a transmission channel controller 40, an interruption processing unit 50, a NAND flash memory interface 60 for coupling with an NAND flash memory 90. The management apparatus 200 is provided for managing the NAND flash memory 90. The NAND flash memory 90 may be of various types.

The embedded microprocessor 10 serves as a central processor unit to manage operations of the NAND flash memory 90 via the NAND flash memory interface 60. It should be noted that other similar controller, such as baseband, digital signal processor, or flash memory controller, may be used as the embedded microprocessor 10 in one embodiment. When the embedded microprocessor 10 requires managing the NAND flash memory 90, it sends a management instruction to the NAND flash memory interface 60. The management instruction may include, but not be limited to, a reading management instruction, a writing management instruction, a copybackread management instruction, a copybackwrite management instruction or other possible management instructions. These management instructions are realized in different ways for different types of NAND flash memories.

The NAND flash memory interface 60 is provided for receiving the management instruments from the embedded microprocessor 10 and embodying them to actual operation instructions and an actual interface time sequence for the NAND flash memory according to the characteristics of the different NAND flashes. Thus, the management apparatus 200 will be compatible with various kinds of NAND flash memories and optimize the access speed to each kind of the NAND flash memories. Further description below will further describe why the NAND flash memory interface 60 can adjust the actual operation instructions and the actual interface time sequence according to the characteristics of an NAND flash memory itself. Additionally, the NAND flash memory interface 60 serves as a bridge between the DMA controller 30 and the NAND flash memory 90 for data transmission.

The DMA controller 30 receives a command from the embedded microprocessor 10 and determines whether the NAND flash memory 90 is communicating with the memory 20 or the transmission channel controller 40. The memory 20 may be implemented by a random access memory in one embodiment. The DMA transmission mode can reduce impact on the embedded microprocessor 10 and raise the data transmission speed. It should be noted that the DMA transmission mode is not unique, other transmission modes may also be used if necessary, for example, the embedded microprocessor can access the NAND flash memory via a port mode.

Depending on application, the data transmission channel controller 40 may be coupled to various devices, such as a personal computer (PC), a personal assistant device (PAD) or a digital camera etc. The interruption process unit 50 is provided for arbitrating interruption requests from the DMA controller 30 and the NAND flash memory interface 60, and sending the result to the embedded microprocessor 10. Thus, the NAND flash interface 60 and the DMA controller 30 may interact with the embedded microprocessor 10 via the interruption control unit 50. Generally, events, such as one management instruction finished, programming errors occurring or irreparable ECC errors occurring, will arise an interruption request. It should be noted that an inquiry mode can be adopted in another embodiment of the present invention for replacing the interruption mode.

When the data transmission channel controller 40 needs to read data from the NAND flash memory 90, it sends a read request to the DMA controller 30. The DMA controller 30 forwards the read request to the embedded microprocessor 10 via the interruption process unit 50. According to the read request, the embedded microprocessor 10 configures the DMA controller 30 and the NAND flash memory interface 60 and sends a read management instruction to the NAND flash memory interface 60. The NAND flash memory interface 60 embodies the management instruction to the actual interface time sequence and reads the data from the NAND flash memory 90. Then, the DMA controller 30 forwards the data into a buffer of the data transmission channel controller 40. After the read operation is finished, the DMA controller 30 notifies the embedded microprocessor 10 via the interruption process unit 50.

Similarly, if the embedded microprocessor 10 requires reading data from the NAND flash memory 90, it configures the DMA controller 30 and the NAND flash memory interface 60 and reads the data into the memory 20. In order to implement the above mentioned functions of the NAND flash memory interface 60, the management apparatus 200 is further provided with a clock definition unit 70 and a type parameter definition unit 80.

The clock definition unit 70 is configured for providing clock signal for the NAND flash memory interface 60 by frequency division of a high frequency clock outputted from a phase lock loop (PLL). The clock definition unit 70 comprises a speed parameter register for registering speed parameters of the NAND flash memory 90, which comprises a minimum circle parameter of read/write enable signal, an effective time duration parameter of high level and an effective time duration parameter of low level in the NAND flash memory. The embedded microprocessor 10 can configure the speed parameter register according to the speed parameters of different NAND flash memories. By reconfiguring the speed parameter register, the clock signal from the clock definition unit 70 can be adjustable. Thus, the clock signal outputted from the clock definition unit 70 is adjustable in frequency and duty cycle according to specialist of different NAND flash memory.

The type parameter definition unit 80 is configured to register type parameters of the NAND flash memory, which comprises a page type parameter, a memory structure parameter, a flag mode parameter of bad blocks, a manufacturer identifier, a volume, special instructions and general instructions etc. The type parameter definition unit 80 can be configured according to the type parameters of the NAND flash memory coupled to the management apparatus 200 by the embedded microprocessor.

To fully understand the present invention, the NAND flash memory interface 60 is further described. Referring to FIG. 1 again, the NAND flash memory interface 60 comprises a protocol selection unit 62 and a waveform generation unit 64. The protocol selection unit 62 is provided for selecting adequate interface protocols for different NAND flash memories according to the type parameters in the type parameter definition unit 80, so that instruction sets corresponding to various NAND flash memories are selected. The waveform generation unit 64 is provided for generating a specific interface time sequence according to the interface protocol selected by the protocol selection unit 62 on the ground of the clock signal from the clock definition unit 70.

The specific interface time sequence comprises two aspects, one is an interface time sequence speed which is directly related to the clock signal from the clock definition unit 70, the other is an interface time sequence waveform which is directly related to the interface protocol selected by the protocol selection unit 62. Thus, speed of different NAND flash memories will be maximized by adjusting adequate clock signal. The NAND flash memory interface 60 will be compatible with various NAND flash memories by selecting corresponding interface protocol. Furthermore, the embedded microprocessor 10 only requires sending management instrument, but not require executing actual operation instrument. Thus, the embedded microprocessor 10 may work at a low frequency and has more time to handle other tasks.

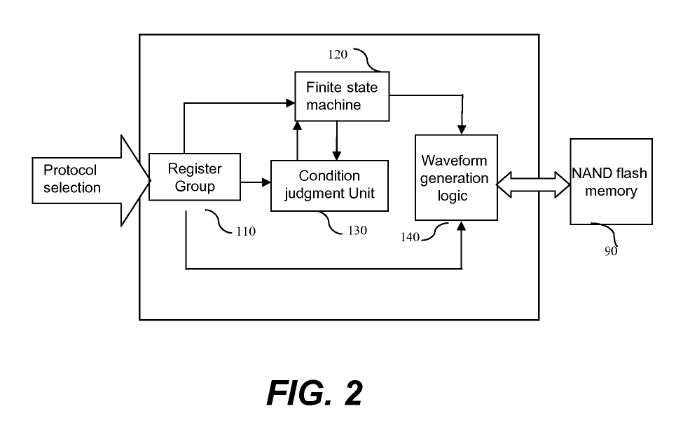

FIG. 2 is a functional block diagram schematically showing the waveform generation unit 64. The waveform generation unit 64 comprises a register group 110, a finite state machine 120, a condition judgment unit 130 and a waveform generation logic 140. All units work under the coordination and control of the clock signal from the clock definition unit 70.

The register group 110 preserves the instruction set selected by the interface protocol unit 62 and provides it to the finite state machine 120, the condition judgment unit 130 and the waveform generation logic 140 for quotation. The condition judgment unit 130 judges contents from the register group 110 as well as status of the finite state machine 120, provides essential parameters including the judgment result to the finite state machine 120. The finite state machine 120 controls steps of waveform generation, while its output is quoted to generate the interface time sequence by the waveform generation logic 140.

In the following context, NAND flash memory of SAMSUNG 32 MB small page type is used as an example to describe operation principle of the management apparatus 200.

When SAMSUNG 32 MB small page type is applied as the NAND flash memory in the present invention, the embedded microprocessor 10 identify the present NAND flash memory and configures the type parameter definition unit 80 according to type parameters of the NAND flash memory and the clock definition unit 70 according to speed parameters of a SAMSUNG NAND flash memory. Specifically, configuring the page type parameter to a small page type, configuring the manufacturer to SAMSUNG, configuring the volume to 32 MB, etc.

The protocol selection unit 62 will select adequate interface protocols for the SAMSUNG NAND flash memory according to the type parameters in the type parameter definition unit 80. Specifically, according to the manufacturer information SAMSUNG, selecting that when a read status instrument is employed, returned status result is processed in SAMSUNG mode; according to the volume 32 MB, determining the addressing range; according to the small page type, selecting small page type instrument set; according to the special instruments, substituting a read instrument and a pageprogram instrument for the copybackread instrument and the copybackwrite instrument due to the SAMSUNG NAND flash memory not supporting for the copybackread instrument and the copybackwrite instrument. The waveform generation unit 64 registers the selected instrument set by the protocol selection module 62.

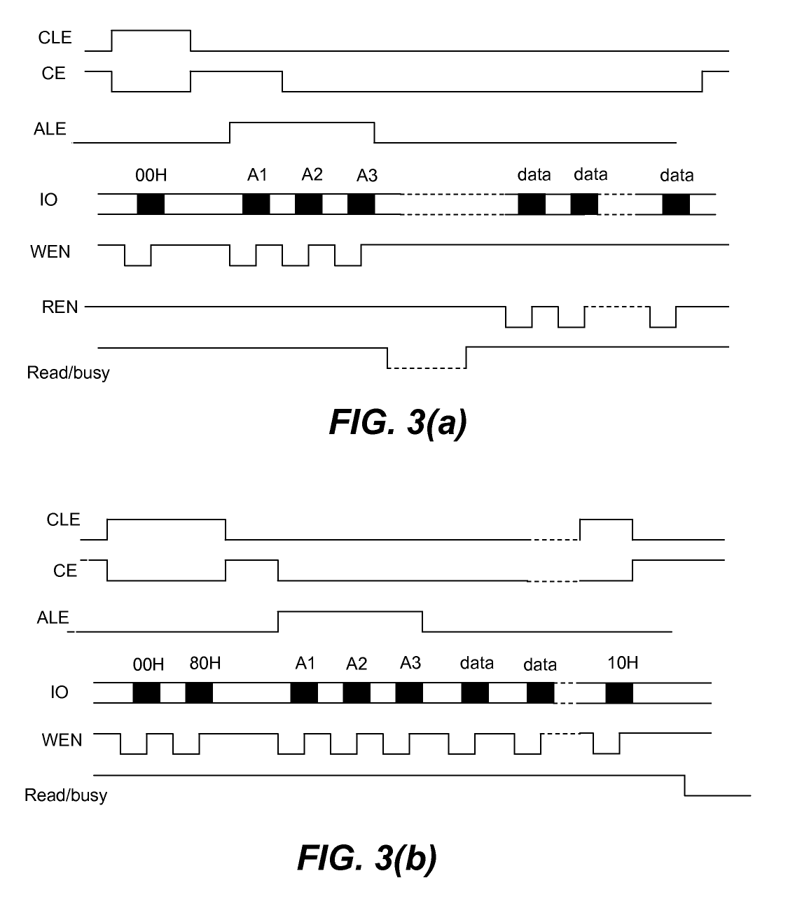

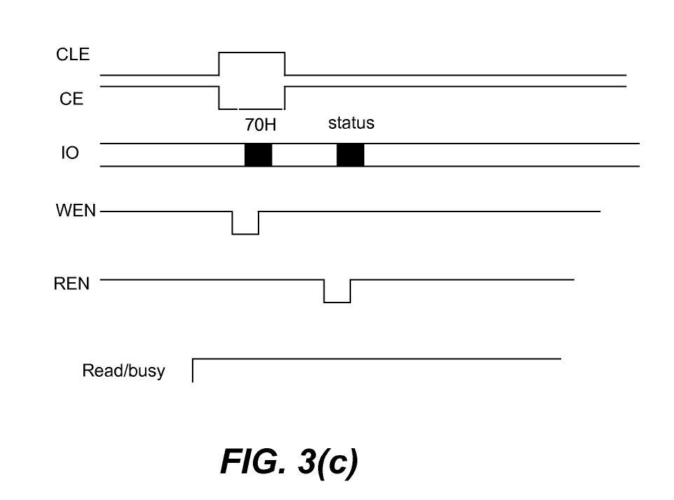

When one copyback operation is needed for the NAND flash memory by the embedded microprocessor 10, first of all, a copybackread instruction is sent to the NAND flash memory interface 60. The waveform generation unit 64 substitutes a read instruction for the copybackread instruction according to the interface protocol selected by the protocol selecting unit 62. Referring to FIG. 3(a), the waveform generation unit 64 generates corresponding interface time sequence waveform according to the read instruction on the ground of the clock signal of the clock definition unit 70. Specifically, to select read point according to an inputted address, to select byte number of the inputted address according to the addressing range, to control command enable (CE) according to the requirement of the small page instructions, etc. The waveform generation unit 64 read data from the NAND flash memory into a cache (not shown) according to the time sequence waveform and accomplishes ECC error correction. Then, the NAND flash memory interface 60 sends an interruption request to the embedded microprocessor 10, which means that the copybackread operation has been accomplished.

Then, the embedded microprocessor 10 sends a copybackwrite instruction to the NAND flash memory interface 60. The waveform generation unit 64 substitutes a pageprogram instruction for the copybackwrite instruction according to the interface protocol selected by the protocol selecting unit 62. Referring to FIG. 3(b), the waveform generation unit 64 generates corresponding interface time sequence waveform according to the pageprogram instrument on the ground of the clock signal of the clock definition unit 70. The waveform generation unit 64 writes data in the cache back into the NAND flash memory 90.

Finally, referring to FIG. 3(c), the waveform generation unit 64 reads out status of the programmed flash memory 90 by a read status instruction, and analyzes it in SAMSUNG status definition mode. If the programming is correct, the NAND flash memory interface 60 will send a correct interruption; If the programming goes wrong, it will send a wrong interruption.

Although the clock definition unit 70 and the type parameter definition unit 80 is equipped outside the NAND flash memory interface 60 in the present embodiment, it should be noted that the two unit 70,80 can also be equipped inside the NAND flash memory interface 60.

While the present invention has been described with reference to specific embodiments, the description is illustrative of the invention and is not to be construed as limiting the invention. Various modifications to the present invention can be made to the preferred embodiments by those skilled in the art without departing from the true spirit and scope of the invention as defined by the appended claims.

What is claimed is:

1. A NAND flash memory interface capable of coupling to various types of NAND flash memories, NAND flash memory interface comprising:
a protocol selection unit provided for selecting adequate interface protocols for a NAND flash memory coupled thereto according to type parameters of the NAND flash memory;
a waveform generation unit provided for generating an interface time sequence for operating the NAND flash memory according to the interface protocol selected by the protocol selection unit.

2. The NAND flash memory interface as claimed in claim 1, further comprising a type parameter definition unit configured for registering the type parameters of the NAND flash memory.

3. The NAND flash memory interface as claimed in claim 2, wherein the type parameter definition unit is configurable according to the type parameters of the NAND flash memory.

4. The NAND flash memory interface as claimed in claim 2, wherein the type parameters comprises a page type, a memory structure, a flag mode parameter of bad blocks, a manufacturer, a volume, special instructions and general instructions.

5. The NAND flash memory interface as claimed in claim 1, further comprising a clock definition unit configured for providing clock signal for the waveform generation unit, and wherein the waveform generation unit generates the interface time sequence on the ground of the clock signal from the clock definition unit.

6. The NAND flash memory interface as claimed in claim 6, wherein the clock definition unit comprises a speed parameter register for registering speed parameters of the coupled NAND flash memory, and wherein the clock signal from the clock definition unit is adjustable in frequency and duty cycle by configuring the speed parameter register.

7. The NAND flash memory interface as claimed in claim 6, wherein the speed parameters comprises a minimum circle of read/write enable signal, an effective time duration of high level and an effective time duration parameter of low level in the NAND flash memory.

8. A device for an NAND flash memory, the device comprising:
a NAND flash memory interface, capable of coupling to various types of NAND flash memories, including a protocol selection unit provided for selecting adequate interface protocols for a NAND flash memory coupled thereto according to type parameters of the NAND flash memory, a waveform generation unit; and
a controller coupling with the NAND flash memory interface, wherein, when the controller requires managing the NAND flash memory, the controller sends a management instruction to the waveform generation unit, the waveform generation unit generates an interface time sequence for operating the NAND flash memory according to the receiving management instrument and the interface protocol selected by the protocol selection unit.

9. The device as claimed in claim 9, further comprising a type parameter definition unit configured for registering the type parameters of the coupled NAND flash memory.

10. The device as claimed in claim 10, wherein the type parameters comprises a page type, a memory structure, a flag mode parameter of bad blocks, a manufacturer, a volume, special instructions and general instructions.

11. The device as claimed in claim 9, further comprising a clock definition unit configured for providing clock signal for the waveform generation unit, and wherein the waveform generation unit generates the interface time sequence on the ground of the clock signal from the clock definition unit.

12. The device as claimed in claim 12, wherein the clock definition unit comprises a speed parameter register for registering speed parameters of the coupled NAND flash memory, and wherein the clock signal from the clock definition unit is adjustable in frequency and duty cycle by configuring the speed parameter register.

13. The device as claimed in claim 12, wherein the speed parameters comprises a minimum circle of read/write enable signal, an effective time duration of high level and an effective time duration parameter of low level in the NAND flash memory.

14. The device as claimed in claim 9, wherein the controller is one of an embedded microprocessor, a baseband, or a digital signal processor.
